(19) United States
(12) Patent Application Publication
(10) Pub. No.: US 2025/0184449 A1
(43) Pub. Date: Jun. 5, 2025

(54) ONLINE CONFERENCE SYSTEM, METHOD FOR CONTROLLING ONLINE CONFERENCE SYSTEM, AND STORAGE MEDIUM

(71) Applicant: NEC Corporation, Minato-ku, Tokyo (JP)

(72) Inventors: Takashi Nonaka, Tokyo (JP); Kiri Inayoshi, Tokyo (JP); Kentaro Nishida, Tokyo (JP)

(73) Assignee: NEC Corporation, Minato-ku, Tokyo (JP)

(21) Appl. No.: 18/844,102

(22) PCT Filed: Mar. 15, 2022
(86) PCT No.: PCT/JP2022/011515

§ 371 Date: Sep. 5, 2024

(51) Int. Cl. H04N 7/15; G06T 13/40; G06T 17/00

(52) U.S. Cl. CPC H04N 7/157; G06T 13/40; G06T 17/00

(57) ABSTRACT

A processor of an online conference system (1): an acquisition process for acquiring an emotion recognition result for a first participant who participates in the online conference; an adjustment process for adjusting a presentation content of the emotion recognition result; and a presentation process for presenting the adjusted presentation content to a second participant different from the first participant.

### TECHNICAL FIELD

The present invention relates to an online conference system, a method for controlling an online conference system, and a program.

### BACKGROUND ART

A technique for presenting, to a speaker, a reaction of another participant to the speaker is required in an online conference.

Patent Literature 1 discloses a system in which an image obtained by capturing a participant by a camera is analyzed to recognize a state of the participant, and a background color of the participant is changed in accordance with the recognized state.

### CITATION LIST

### Patent Literature

### [Patent Literature 1]

Japanese Patent No. 6872066

### SUMMARY OF INVENTION

### Technical Problem

The system disclosed in Patent Literature 1 has a problem such that a state specific to each individual participant is not considered. For example, there is the following problem: even if a participant in a good mood or a participant with a lot of smiles has a negative emotion toward an utterance of a speaker, the participant is not recognized as having a negative emotion toward the utterance of the speaker.

An example aspect of the present invention has been made in view of the above-described problems, and an example object thereof is to provide a technique for suitably presenting a reaction of a participant in an online conference.

### Solution to Problem

An online conference system according to an example aspect of the present invention includes: an acquisition means for acquiring an emotion recognition result for a first participant who participates in an online conference; an adjustment means for adjusting a presentation content of the emotion recognition result; and a presentation means for presenting the adjusted presentation content to a second participant different from the first participant.

A method for controlling an online conference system according to an example aspect of the present invention includes: (a) acquiring an emotion recognition result for a first participant who participates in an online conference; (b) adjusting a presentation content of the emotion recognition result; and (c) presenting the adjusted presentation content to a second participant different from the first participant, (a), (b), and (c) each being carried out by at least one processor.

A program according to an example aspect of the present invention causes a computer to function as: an acquisition means for acquiring an emotion recognition result for a first participant who participates in an online conference; an adjustment means for adjusting a presentation content of the emotion recognition result; and a presentation means for presenting the adjusted presentation content to a second participant different from the first participant.

### Advantageous Effects of Invention

An example aspect of the present invention makes it possible to suitably present a reaction of a participant in an online conference.

### BRIEF DESCRIPTION OF DRAWINGS

FIG. 1 is a block diagram illustrating a configuration of an online conference system according to a first example embodiment of the present invention.

FIG. 2 is a flowchart showing a flow of a method for controlling the online conference system according to the first example embodiment of the present invention.

FIG. 3 is a block diagram illustrating a configuration of an online conference system according to a second example embodiment of the present invention.

FIG. 4 is an example of an image displayed for acquiring first setting information and second setting information in the second example embodiment of the present invention.

FIG. 5 is a view illustrating an example of an avatar placed in a virtual space by a generation section in the second example embodiment of the present invention.

FIG. 6 is a sequence diagram showing a flow of a method for controlling the online conference system according to the second example embodiment of the present invention.

FIG. 7 is a sequence diagram showing a flow of a process of an online conference carried out in the online conference system according to the second example embodiment of the present invention.

FIG. 8 is a view illustrating an example of a conference image of an online conference which conference image is generated by the generation section in the second example embodiment of the present invention.

FIG. 9 is a sequence diagram showing a flow of a method for controlling an online conference system according to a third example embodiment of the present invention.

FIG. 10 is a view illustrating an example of a presentation content displayed on a display by a display section in the third example embodiment of the present invention.

FIG. 11 is a block diagram illustrating an example of a hardware configuration of each of an online conference system, a server, a virtual reality device, and an emotion recognition apparatus in example embodiments of the present invention.

### EXAMPLE EMBODIMENTS

### First Example Embodiment

The following description will discuss a first example embodiment of the present invention in detail with reference to the drawings. The present example embodiment is an embodiment serving as a basis for example embodiments described later.

### (Overview of Online Conference System 1)

The online conference system 1 according to the present example embodiment is a system that, by providing video, audio, and data to each of a plurality of computers, enables respective users of the plurality of computers to communicate with each other. Any one of the plurality of computers or another computer (e.g., a server) capable of communicating with each of the plurality of computers may be configured to have a function of the online conference system 1.

Further, the online conference system 1 according to the present example embodiment is a system that acquires an emotion recognition result for a first participant who participates in an online conference, adjusts a presentation content of the emotion recognition result, and presents the presentation content to a second participant different from the first participant.

The first participant and the second participant are not particularly limited and need only be participants who participate in a conference. For example, the first participant is a participant who is listening to an utterance, and the second participant is a participant who makes an utterance.

Adjusting the presentation content of the emotion recognition result refers to changing an emotion included in the emotion recognition result, or a degree of the emotion, and including, in the presentation content, the emotion recognition result obtained after changing the emotion or the degree of the emotion. In other words, the presentation content includes the emotion recognition result, and the emotion recognition result is adjustable. The presentation content is presented to at least the second participant who makes an utterance, but may also be presented to the first participant in addition to the second participant.

For example, the online conference system 1 includes, in the presentation content, an emotion recognition result that has been obtained by adjusting a degree of part or whole of an emotion included in the emotion recognition result, or includes, in the presentation content, an emotion recognition result that has been adjusted so as not to include, in the presentation content, part or whole of an emotion included in the emotion recognition result.

As a more specific example, the online conference system 1 includes, in the presentation content, a positive emotion recognition result that is included in the emotion recognition result, and includes, in the presentation content, no negative emotion recognition result that is included in the emotion recognition result. Examples of the positive emotion include happiness, pleasantness, and security. Examples of the negative emotion include sadness, anger, and anxiety.

With this configuration, in the online conference system 1, in a case where the first participant listens to an utterance of the second participant and has a negative emotion, the negative emotion is not presented to the second participant. Thus, since the online conference system 1 does not present, to the second participant, a negative emotion of which the first participant does not wish the second participant to be aware, it is possible to facilitate communication between the first participant and the second participant.

As another example, the online conference system 1 includes, in the presentation content, the emotion recognition result that has been changed by suppressing or emphasizing an emotion included in the emotion recognition result.

With this configuration, for example, in a case where the first participant is a person who has terrible emotional ups and downs, the online conference system 1 suppresses an emotion and includes the emotion in the presentation content. In a case where the first participant is a person who has no emotional ups and downs, the online conference system 1 emphasizes an emotion and includes the emotion in the presentation content. Thus, the online conference system 1 makes it possible to suitably present a reaction of a participant in an online conference.

The emotion recognition result can be acquired by using a known technique. Examples of a technique for acquiring the emotion recognition result include a technique for acquiring an emotion recognition result by analyzing a physiological indicator, a facial expression, and a voice of a user and visualizing a positive emotion and a negative emotion. Examples of the physiological indicator of the user include pulse waves, brain waves, heartbeats, and sweating.

### (Configuration of Online Conference System 1)

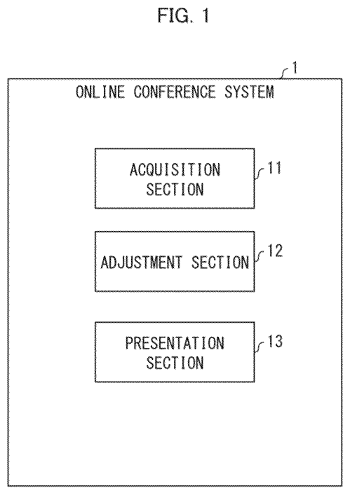

The following description will discuss, with reference to FIG. 1, a configuration of the online conference system 1 according to the present example embodiment. FIG. 1 is a block diagram illustrating the configuration of the online conference system 1 according to the present example embodiment.

The online conference system 1 according to the present example embodiment includes an acquisition section 11, an adjustment section 12, and a presentation section 13 as illustrated in FIG. 1. The acquisition section 11, the adjustment section 12, and presentation section 13 are configured to realize an acquisition means, an adjustment means, and a presentation means, respectively, in the present example embodiment.

The acquisition section 11 acquires an emotion recognition result for a first participant who participates in an online conference. The acquisition section 11 supplies the acquired emotion recognition result to the adjustment section 12.

The adjustment section 12 adjusts a presentation content of the emotion recognition result supplied from the acquisition section 11. The adjustment section 12 supplies the adjusted presentation content to the presentation section 13. A process in which the adjustment section 12 adjusts the presentation content is as described earlier.

The presentation section 13 presents, to a second participant different from the first participant, the presentation content adjusted by the adjustment section 12.

As described above, a configuration is employed such that the online conference system 1 according to the present example embodiment includes: the acquisition section 11 that acquires an emotion recognition result for a first participant who participates in an online conference; the adjustment section 12 that adjusts a presentation content of the emotion recognition result; and the presentation section 13 that presents the adjusted presentation content a second participant different from the first participant.

Thus, according to the online conference system 1 according to the present example embodiment, the presentation content including the adjusted emotion recognition result for the first participant is presented to the second participant. This brings about an effect of making it possible to suitably present a reaction of a participant in an online conference.

### (Flow of Control Method S1 for Online Conference System)

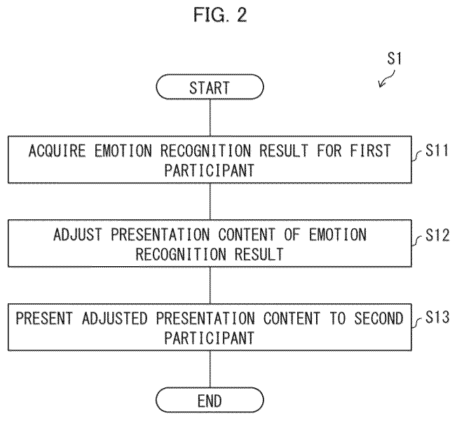

The following description will discuss, with reference to FIG. 2, a flow of a control method S1 for the online conference system 1 according to the present example embodiment. FIG. 2 is a flowchart illustrating the flow of the control method S1 for the online conference system 1 according to the present example embodiment.

### (Step S11)

In step S11, the acquisition section 11 acquires an emotion recognition result for a first participant who participates in an online conference. The acquisition section 11 supplies the acquired emotion recognition result to the adjustment section 12.

### (Step S12)

In step S12, the adjustment section 12 adjusts a presentation content of the emotion recognition result supplied from the acquisition section 11 in step S11. The adjustment section 12 supplies the adjusted presentation content to the presentation section 13. A process in which the adjustment section 12 adjusts the presentation content is as described earlier.

### (Step S13)

In step S13, the presentation section 13 presents, to a second participant different from the first participant, the presentation content adjusted by the adjustment section 12 in step S12.

As described above, in the control method S1 for the online conference system according to the present example embodiment, the acquisition section 11 acquires, in step S11, an emotion recognition result for a first participant who participates in an online conference, the adjustment section 12 adjusts, in step S12, a presentation content of the emotion recognition result supplied from the acquisition section 11 in step S11, and, in step S13, the presentation section 13 presents, to a second participant different from the first participant, the presentation content adjusted by the adjustment section 12 in step S12.

Thus, the control method S1 for the online conference system according to the present example embodiment brings about an effect similar to the effect brought about by the above-described online conference system 1.

### Second Example Embodiment

The following description will discuss a second example embodiment of the present invention in detail with reference to the drawings. Note that members having functions identical to those of the respective members described in the first example embodiment are given respective identical reference numerals, and a description of those members is omitted as appropriate.

### (Configuration of Online Conference System 100)

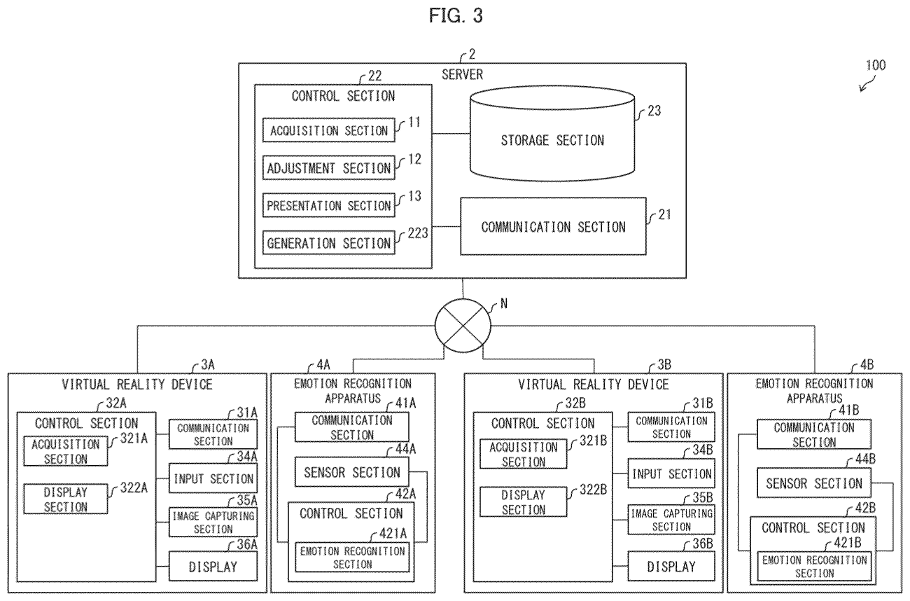

The following description will discuss, with reference to FIG. 3, a configuration of an online conference system 100 according to the present example embodiment. FIG. 3 is a block diagram illustrating the configuration of the online conference system 100 according to the present example embodiment.

The online conference system 100 according to the present example embodiment is configured to include a server 2, a virtual reality device 3A, an emotion recognition apparatus 4A, a virtual reality device 3B, and an emotion recognition apparatus 4B as illustrated in FIG. 3. Note that, in the present example embodiment, the virtual reality device 3A and the virtual reality device 3B which need not be particularly distinguished from each other are each simply referred to as “virtual reality device 3”. Similarly, the emotion recognition apparatus 4A and the emotion recognition apparatus 4B which need not be particularly distinguished from each other are each simply referred to as “emotion recognition apparatus 4”.

The description of the present example embodiment takes, as an example, a case where a user of the virtual reality device 3A is listening to an utterance of a user of the virtual reality device 3B. Note, however, a configuration of the online conference system 100 is not limited to this configuration. In other words, in the online conference system 100, the virtual reality device 3 and the emotion recognition apparatus 4 that are used by a user who is listening to an utterance are referred to as the virtual reality device 3A and the emotion recognition apparatus 4A, respectively, and the virtual reality device 3 and the emotion recognition apparatus 4 that are used by a user who is making an utterance are referred to as the virtual reality device 3B and the emotion recognition apparatus 4B, respectively. Note here that the user who is listening to an utterance and the user who is making an utterance are also referred to as a first participant and a second participant, respectively.

The online conference system 100 illustrated in FIG. 3 includes two virtual reality devices 3 and two emotion recognition apparatuses 4. Note, however, that the number of virtual reality devices 3 and the number of emotion recognition apparatuses 4 are not limited.

As illustrated in FIG. 3, the server 2, the virtual reality device 3A, the emotion recognition apparatus 4A, the virtual reality device 3B, and the emotion recognition apparatus 4B are connected with each other via a network N so as to be capable of communicating with each other. A specific configuration of the network N is not limited to the present example embodiment. Examples of the network N include a wireless local area network (LAN), a wired LAN, a wide area network (WAN), a public network, a mobile data communication network, and a combination of these networks.

In the online conference system 100, the server 2 that provides video, audio, and data to the virtual reality device 3A and the virtual reality device 3B enables respective users of the virtual reality device 3A and the virtual reality device 3B to communicate with each other.

Further, in the online conference system 100, the emotion recognition apparatus 4A recognizes an emotion of the user of the virtual reality device 3A, and outputs an emotion recognition result to the server 2. The server 2 adjusts a presentation content of the emotion recognition result acquired, and outputs the adjusted presentation content to the virtual reality device 3B.

### (Configuration of Server 2)

The server 2 includes a communication section 21, a control section 22, and a storage section 23 as illustrated in FIG. 3.

The communication section 21 is a communication module that communicates with another apparatus via the network N. For example, the communication section 21 outputs, to another apparatus via the network N, data supplied from the control section 22 (described later), and acquires, via the network N, data output from another apparatus, and supplies the data to the control section 22.

The storage section 23 stores data to which the control section 22 refers. Examples of the data stored in the storage section 23 include the emotion recognition result, the presentation content, and first setting information and second setting information, each of which will be described later.

### (Function of Control Section 22)

The control section 22 controls members of the server 2. The control section 22 also functions as an acquisition section 11, an adjustment section 12, a presentation section 13, and a generation section 223 as illustrated in FIG. 3. The acquisition section 11, the adjustment section 12, the presentation section 13, and the generation section 223 are configured to realize an acquisition means, an adjustment means, a presentation means, and a generation means, respectively, in the present example embodiment.

The acquisition section 11 acquires data supplied from the communication section 21. Examples of the data acquired by the acquisition section 11 include emotion recognition results (an emotion recognition result for the first participant and an emotion recognition result), and the first setting information, the second setting information, first attribute information, second attribute information, and closeness information, each of which will be described later. The acquisition section 11 stores the acquired data in the storage section 23.

The adjustment section 12 acquires the emotion recognition result stored in the storage section 23, and adjusts a presentation content of the emotion recognition result. Further, the adjustment section 12 adjusts the presentation content of the emotion recognition result on the basis of data acquired from the virtual reality device 3. Furthermore, the adjustment section 12 may adjust a speech content of the second participant, a movement of the second participant, and an avatar of a participant. An example of a process in which the adjustment section 12 adjusts the presentation content will be described later. The adjustment section 12 stores the adjusted presentation content in the storage section 23.

The presentation section 13 presents the presentation content to the second participant by outputting the presentation content to the virtual reality device 3B via the communication section 21. For example, the presentation section 13 acquires, from the storage section 23, a conference image that has been generated by the generation section 223 (described later) and that includes the adjusted presentation content, and outputs the conference image to the virtual reality device 3 via the communication section 21. As another example, the presentation section 13 outputs, to the virtual reality device 3A, a conference image that includes no presentation content, and outputs, to the virtual reality device 3B, a conference image that includes the presentation content. An example of the conference image output by the presentation section 13 will be described later.

Further, the presentation section 13 may be configured to present the emotion recognition result in real time. In other words, the presentation section 13 may output the presentation content at least at a timing at which the presentation content is changed during an online conference. This configuration enables the presentation section 13 to present an emotion of the first participant to the second participant in real time.

The generation section 223 generates a conference image of an online conference which conference image is to be displayed on the virtual reality device 3. For example, the generation section 223 acquires the presentation content stored in the storage section 23, and generates a conference image including the presentation content. The generation section 223 stores the generated conference image in the storage section 23.

Further, the generation section 223 may generate a virtual space for holding an online conference. For example, the generation section 223 may generate a virtual space in which an avatar of at least one selected from the group consisting of the first participant and the second participant is placed. The avatar used by the generation section 223 may be configured to be acquired from the virtual reality device 3, or may be configured such that a user ID for distinguishing a user from another user and an avatar are stored in advance in the storage section 23 in association with each other, and the user ID is acquired from the virtual reality device 3.

Furthermore, the generation section 223 that has generated a virtual space in which an avatar(s) is/are placed acquires the presentation content stored in the storage section 23, and places, in the virtual space, an avatar which is in accordance with the presentation content. The avatar that is placed in the virtual space by the generation section 223 and that is in accordance with the presentation content will be described later.

### (Configuration of Virtual Reality Device 3A)

The virtual reality device 3A includes a communication section 31A, a control section 32A, an input section 34A, an image capturing section 35A, and a display 36A as illustrated in FIG. 3.

The communication section 31A is a communication module that communicates with another apparatus via the network N. For example, the communication section 31A outputs, to another apparatus via the network N, data supplied from the control section 32A (described later), and acquires, via the network N, data output from another apparatus, and supplies the data to the control section 32A.

The input section 34A is an interface that receives input from a user. The input section 34A supplies, to the control section 32A, input information that indicates the received input from the user. Examples of the input received by the input section 34A include the first setting information that has been input by the first participant, the first attribute information that has been input by the first participant and that indicates an attribute of the first participant, and the closeness information that has been input by the first participant and that indicates closeness between the first participant and the second participant.

Note here that the first setting information is information in which how the first participant causes the server 2 to adjust the presentation content of the emotion recognition result is set. In other words, the first setting information is information that indicates how the first participant wishes an emotion of the first participant to be adjusted and presented to the second participant. Examples of the first setting information include emphasizing (or suppressing) a positive emotion (or a negative emotion). An example of a process for receiving input of the first setting information will be described later.

Further, examples of the attribute of the first participant include sex, age, a birthplace, a place of residence, an occupation, and clothing.

The image capturing section 35A is a camera capable of capturing a moving image. The image capturing section 35A supplies the captured moving image to the control section 32A. Examples of the moving image captured by the image capturing section 35A include a moving image including a face of a user as a subject.

The display 36A is a device that displays an image. The display 36 acquires image data supplied from the control section 32A, and displays an image indicated by the image data. Examples of the image displayed by the display 36A include an image of an online conference.

### (Function of Control Section 32A)

The control section 32A controls members of the virtual reality device 3A. The control section 32A also functions as an acquisition section 321A and a display section 322A as illustrated in FIG. 3.

The acquisition section 321A acquires data supplied from the communication section 31A, the input section 34A, and the image capturing section 35A. The acquisition section 321A outputs the acquired data to the server 2 via the communication section 31A, and supplies the acquired data to the display section 322A (described later).

The display section 322A acquires an image to be displayed on the display 36A, and supplies, to the display 36A, image data indicating the image. In the following description, the display section 322A supplying image data to the display 36A, which displays an image indicated by the image data is also described as the display section 322A displaying an image on the display 36A.

### (Configuration of Emotion Recognition Apparatus 4A)

The emotion recognition apparatus 4A includes a communication section 41A, a control section 42A, and a sensor section 44A as illustrated in FIG. 3.

The communication section 41A is a communication module that communicates with another apparatus via the network N. For example, the communication section 41A outputs, to another apparatus via the network N, data supplied from the control section 42A (described later), and acquires, via the network N, data output from another apparatus, and supplies the data to the control section 42A.

The control section 42A controls members of the emotion recognition apparatus 4A. The control section 42A also functions as an emotion recognition section 421A as illustrated in FIG. 3.

The emotion recognition section 421A recognizes an emotion of the first participant on the basis of sensor information supplied from the sensor section 44A (described later). A process in which the emotion recognition section 421A recognizes the emotion of the first participant is as described earlier. The emotion recognition section 421A generates an emotion recognition result that indicates the recognized emotion, and outputs the generated emotion recognition result to the server 2 via the communication section 41A. Examples of the emotion recognition result include an emotion recognition result which indicates that the first participant has a positive emotion, and an emotion recognition result which indicates that the first participant has a negative emotion.

The emotion recognition section 421A may also include a degree of the recognized emotion in the emotion recognition result. For example, the emotion recognition section 421A may indicate the degree of the emotion in ten levels and include, in the emotion recognition result, the degree thus indicated.

The emotion recognition section 421A may also output the sensor information as the emotion recognition result to the server 2 via the communication section 41A, the sensor information having been supplied from the sensor section 44A.

The sensor section 44A is a sensor that detects at least one selected from the group consisting of a physiological indicator, a facial expression, and a voice of the first participant. The sensor section 44A supplies, to the control section 42A, sensor information that indicates the detected at least one selected from the group consisting of the physiological indicator, the facial expression, and the voice.

### (Configurations of Virtual Reality Device 3B and Emotion Recognition Apparatus 4B)

The virtual reality device 3B is a virtual reality device used by the second participant. The virtual reality device 3B acquires and outputs the second setting information in place of the first setting information acquired and output by the above-described virtual reality device 3A. The second setting information is information which has been input by the second participant and in which how the server 2 adjusts the presentation content of the emotion recognition result is set. In other words, the second setting information is information that indicates how the second participant wishes an emotion of the first participant to be adjusted and presented. Since the rest of the configuration of the virtual reality device 3B is identical to that of the above-described virtual reality device 3A, a description thereof is omitted.

Further, the virtual reality device 3B acquires and outputs, in place of (i) the first attribute information which is acquired and output by the above-described virtual reality device 3A and which indicates the attribute of the first participant and (ii) closeness between the first participant and the second participant which closeness is acquired and output by the above-described virtual reality device 3A, (a) the second attribute information which indicates an attribute of the second participant and (b) closeness between the second participant and the first participant. Examples of the attribute are as described earlier.

The emotion recognition apparatus 4B is an emotion recognition apparatus that recognizes an emotion of the second participant. Since a configuration of the emotion recognition apparatus 4B is identical to that of the above-described emotion recognition apparatus 4A, a description thereof is omitted.

### (Example of Process for Acquiring First Setting Information and Second Setting Information)

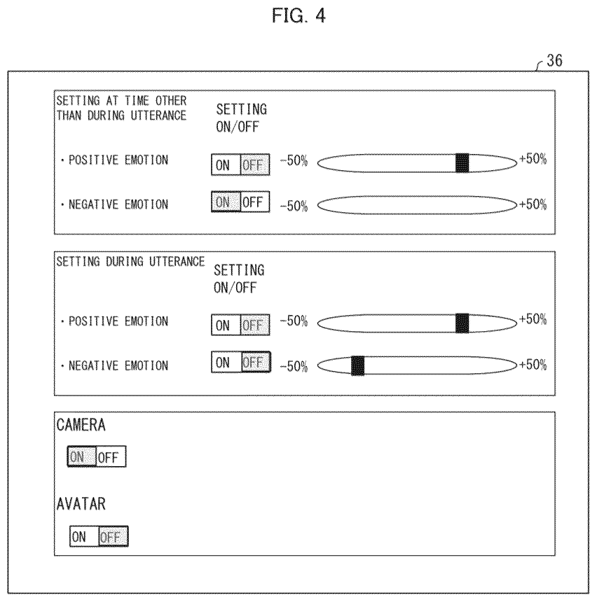

The following description will discuss, with reference to FIG. 4, an example of a process in which the virtual reality device 3 acquires the first setting information and the second setting information. FIG. 4 is an example of an image displayed for acquiring the first setting information and the second setting information in the present example embodiment.

In a case where the virtual reality device 3 receives, from the first participant or the second participant, input indicating that an online conference is to be started, the display section 322 displays, on the display 36, an image for acquiring the first setting information and the second setting information. For example, the display section 322 displays, on the display 36, an image illustrated in FIG. 4.

As illustrated in FIG. 4, an image for acquiring the first setting information and the second setting information includes an item related to the first setting information (an item included in “SETTING AT TIME OTHER THAN DURING UTTERANCE” in FIG. 4) and an item related to the second setting information (an item included in “SETTING DURING UTTERANCE” in FIG. 4).

For example, in a case where a user turns “ON” a setting of an item “POSITIVE EMOTION” in “SETTING AT TIME OTHER THAN DURING UTTERANCE”, and further sets “POSITIVE EMOTION” to “+20%”, the acquisition section 321 acquires the first setting information which indicates that a positive emotion is emphasized by 20%.

As another example, in a case where a user turns “OFF” a setting of an item “NEGATIVE EMOTION” in “SETTING DURING UTTERANCE”, the acquisition section 321 acquires the second setting information which indicates that a negative emotion is not included.

Note here that an image for acquiring one of the first setting information and the second setting information may be displayed in a case where, for example, a person who makes an utterance and a person who listens to an utterance are fixed as in a lecture meeting.

Further, as illustrated in FIG. 4, an image for acquiring the first setting information and the second setting information may include an item for selecting whether to hold an online conference which includes a moving image captured by the image capturing section 35, and an item for selecting whether to hold an online conference in which an avatar is placed in a virtual space.

### First Example of Process in which Adjustment Section 12 Adjusts Presentation Content of Emotion Recognition Result

For example, the adjustment section 12 may adjust the presentation content on the basis of the first setting information input by the first participant.

For example, in a case where the first setting information indicates that a positive emotion recognition result for the first participant is included in the presentation content and that no negative emotion recognition result for the first participant is included in the presentation content, the adjustment section 12 may adjust the presentation content on the basis of the first setting information.

In this configuration, in a case where the emotion recognition result for the first participant is a negative emotion recognition result, the adjustment section 12 does not include such a negative emotion result in the presentation content.

In contrast, in a case where the emotion recognition result for the first participant is a positive emotion recognition result, the adjustment section 12 includes such a positive emotion result in the presentation content.

As another example, in a case where the first setting information indicates that an emotion is suppressed or emphasized, the adjustment section 12 may adjust the presentation content on the basis of the first setting information.

In this configuration, in a case where the first setting information indicates that a positive emotion is emphasized by 20%, and the emotion recognition result for the first participant indicates that the first participant has a positive emotion, the adjustment section 12 includes, in the presentation content, the emotion recognition result that has been adjusted by emphasizing, by 20%, the positive emotion indicated by the emotion recognition result.

In contrast, in a case where the first setting information indicates that a negative emotion is suppressed by 30%, and the emotion recognition result for the first participant indicates that the first participant has a negative emotion, the adjustment section 12 includes, in the presentation content, the emotion recognition result that has been adjusted by suppressing, by 30%, the negative emotion indicated by the emotion recognition result.

The adjustment section 12 that thus adjusts the presentation content on the basis of the first setting information enables the first participant itself to adjust an emotion of the first participant which emotion is to be presented to the second participant. This makes it possible to suitably present, to the second participant, a reaction of the first participant who participates in an online conference.

For example, with this configuration, in a case where the first participant who is feeling depressed participates in the online conference, the adjustment section 12 can adjust the presentation content so as to indicate, to the second participant, that the first participant is not necessarily feeling depressed by an utterance of the second participant.

### Second Example of Process in which Adjustment Section 12 Adjusts Presentation Content of Emotion Recognition Result

As another example, the adjustment section 12 may adjust the presentation content on the basis of the second setting information input by the second participant.

For example, in a case where the second setting information indicates that a positive emotion recognition result is included in the presentation content and that no negative emotion recognition result is included in the presentation content, and the emotion recognition result for the first participant is a negative emotion recognition result, the adjustment section 12 need not include such a negative emotion result in the presentation content. In contrast, in a case where the emotion recognition result for the first participant is a positive emotion recognition result, the adjustment section 12 may include such a positive emotion result in the presentation content.

As another example, in a case where the second setting information indicates that an emotion is suppressed or emphasized, the adjustment section 12 may adjust the presentation content on the basis of the second setting information.

For example, in a case where the second setting information indicates that a positive emotion is emphasized by 20%, and the emotion recognition result for the first participant indicates that the first participant has a positive emotion, the adjustment section 12 may include, in the presentation content, the emotion recognition result that has been adjusted by emphasizing, by 20%, the positive emotion indicated by the emotion recognition result.

In contrast, in a case where the second setting information indicates that a negative emotion is suppressed by 30%, and the emotion recognition result for the first participant indicates that the first participant has a negative emotion, the adjustment section 12 may include, in the presentation content, the emotion recognition result that has been adjusted by suppressing, by 30%, the negative emotion indicated by the emotion recognition result.

The adjustment section 12 that thus adjusts the presentation content on the basis of the second setting information enables the second participant itself to adjust an emotion of the first participant which emotion is to be presented to the second participant. This makes it possible to suitably present, to the second participant, a reaction of the first participant who participates in the online conference.

With this configuration, for example, in a case where the second participant does not wish to be aware that an utterance of the second participant has caused the first participant to have a negative emotion, even if the first participant has a negative emotion, the adjustment section 12 can adjust the presentation content so as to indicate to the second participant that the first participant has no negative emotion.

### Third Example of Process in which Adjustment Section 12 Adjusts Presentation Content of Emotion Recognition Result

As still another example, the adjustment section 12 adjusts the presentation content on the basis of an attribute of one or both of the first participant and the second participant.

For example, in a case where the first attribute information indicates that the first participant is in his/her fifties and that an occupation of the first participant is a teacher, and the emotion recognition result for the first participant is a positive emotion recognition result, the adjustment section 12 may emphasize the positive emotion recognition result and include the positive emotion recognition result in the presentation content. In other words, in a case where the attribute indicated by the first attribute information is an attribute from which the first participant is estimated to be a person who is not so frank, the adjustment section 12 may emphasize the positive emotion recognition result for the first participant and include the positive emotion recognition result in the presentation content.

In this case, the adjustment section 12 may further change the speech content of the second participant to a polite content. In other words, in a case where the attribute indicated by the first attribute information is an attribute from which the first participant is estimated to be a person who is not so frank, the adjustment section 12 may adjust behavior of the second participant so that the behavior will be polite. Note here that the adjustment section 12 may adjust not only the speech content but also a movement of the second participant so that the movement will be polite.

As another example, the adjustment section 12 may change the speech content of the second participant to a polite content in a case where the second attribute information indicates that the second participant is in his/her twenties and that an occupation of the second participant is related to entertainment. In other words, in a case where the attribute indicated by the second attribute information is an attribute from which the second participant is estimated to be a person who is frank, the adjustment section 12 may adjust behavior of the second participant so that the behavior will be polite.

As still another example, in a case where the second participant participates in the online conference as an avatar, and the first attribute information indicates that clothing of the first participant is formal, the adjustment section 12 may adjust clothing of the avatar of the second participant so that the clothing will also be formal. In other words, in a case where the attribute indicated by the first attribute information is an attribute from which the online conference is estimated to be a serious conference, the adjustment section 12 may adjust the clothing of the avatar of the second participant so that the clothing will also match the serious conference.

By thus adjusting the presentation content on the basis of an attribute of one or both of the first participant and the second participant, the adjustment section 12 can facilitate communication between the participants in the online conference.

### Fourth Example of Process in which Adjustment Section 12 Adjusts Presentation Content of Emotion Recognition Result

As a further example, the adjustment section 12 may adjust the presentation content on the basis of closeness between the first participant and the second participant.

For example, in a case where the closeness information which has been output from the virtual reality device 3A and which indicates closeness between the first participant and the second participant indicates that the first participant has met the second participant for the first time, and the emotion recognition result for the first participant is a positive emotion recognition result, the adjustment section 12 may emphasize the emotion recognition result and include the emotion recognition result in the presentation content. In other words, in a case where closeness between the first participant and the second participant is low, the adjustment section 12 may emphasize the positive emotion recognition result for the first participant and include the positive emotion recognition result in the presentation content.

Further, in a case where closeness between the first participant and the second participant is low and at least one of the first participant and the second participant participates in the online conference as an avatar, the adjustment section 12 may adjust behavior of a participant so that the behavior will be polite, the participant participating as the avatar.

In accordance with an increase in closeness between the first participant and the second participant, the adjustment section 12 may decrease a degree by which the emotion recognition result is emphasized.

Note here that the adjustment section 12 may estimate closeness.

For example, the adjustment section 12 may estimate closeness on the basis of the number of times the online conference is held by the first participant and the second participant. For example, the adjustment section 12 may be configured to increase closeness in a case where the number of times the online conference is held by the first participant and the second participant exceeds a certain number of times (for example, five times).

As another example, the adjustment section 12 may estimate closeness on the basis of a content of an utterance made by the first participant. For example, the adjustment section 12 may be configured to increase closeness in a case where the content of the utterance made by the first participant was a frank content.

By thus adjusting the presentation content on the basis of closeness between the first participant and the second participant, the adjustment section 12 can facilitate communication between the participants in the online conference.

### Fifth Example of Process in which Adjustment Section 12 Adjusts Presentation Content of Emotion Recognition Result

As a still further example, the adjustment section 12 may adjust the presentation content during the online conference on the basis of at least one selected from the group consisting of sensor information detected during the online conference, the emotion recognition result for the first participant, and the emotion recognition result for the second participant.

For example, in a case where there are a plurality of first participants, the adjustment section 12 is configured to adjust the presentation content during the online conference on the basis of emotion recognition results for the respective plurality of first participants.

In the case of this configuration, for example, in a case where the emotion recognition result indicates that, among the plurality of first participants, not less than a certain number (e.g., not less than 80% of the entire participants) of first participants have a positive emotion, the adjustment section 12 may adjust emotion recognition results for all the first participants to an emotion recognition result which indicates that all the first participants have a positive emotion.

As another example, the adjustment section 12 is configured to adjust the presentation content during the online conference on the basis of the emotion recognition result for the first participant.

In the case of this configuration, for example, in a case where the emotion recognition result for the first participant has a positive emotion for not less than a certain period of time (e.g., 5 minutes), the adjustment section 12 may adjust the emotion recognition result for the first participant to the emotion recognition result in which the positive emotion is emphasized.

As still another example, the adjustment section 12 is configured to adjust the presentation content during the online conference on the basis of the sensor information detected during the online conference and the emotion recognition result for the second participant.

For example, in a case where an utterance content indicated by the sensor information is a content of an utterance made by the second participant to make an apology, the adjustment section 12 may adjust the emotion recognition result for the second participant to an emotion with a stronger feeling of apology.

As another example of this configuration, in a case where a speed at which the second participant speaks and which is indicated by the sensor information is fast, the adjustment section 12 may adjust the speed so that the second participant speaks at a slower speed. Further, in a case where the second participant participates in the online conference as the avatar, the adjustment section 12 may adjust the movement of the second participant so that the movement will be intense.

By thus adjusting the presentation content during the online conference on the basis of at least one selected from the group consisting of the sensor information detected during the online conference, the emotion recognition result for the first participant, and the emotion recognition result for the second participant, the adjustment section 12 can facilitate communication between the participants in the online conference.

(Example of Avatar in Accordance with Presentation Content)

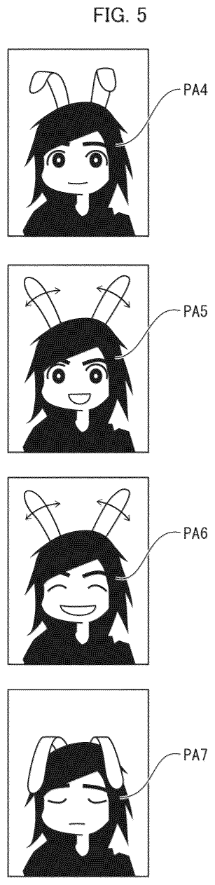

The following description will use FIG. 5 to describe an example of an avatar that is placed in a virtual space by the generation section 223 and that is in accordance with the presentation content. FIG. 5 is a view illustrating an example of the avatar placed in the virtual space by the generation section 223 in the present example embodiment.

The generation section 223 may control a facial expression of the avatar in accordance with the presentation content.

For example, in a case where an emotion recognition result for a participant which emotion recognition result is included in the presentation content indicates that an emotion of the participant is in a neutral state, the generation section 223 places, in the virtual space, the avatar that has a facial expression in ordinary times, as illustrated in a participant PA4 in FIG. 5.

As another example, in a case where an emotion recognition result for a participant which emotion recognition result is included in the presentation content indicates that an emotion of the participant is positive, the generation section 223 places, in the virtual space, the avatar whose eyes are opened wide, whose mouth corners are raised, and whose facial expression looks happy, as illustrated in a participant PA5 in FIG. 5.

As still another example, in a case where an emotion recognition result for a participant which emotion recognition result is included in the presentation content indicates that an emotion of the participant is positive and that the positive emotion is further emphasized, the generation section 223 places, in the virtual space, the avatar who is all smiles, whose mouth corners are raised, and whose facial expression looks happier, as illustrated in a participant PA6 in FIG. 5.

As a further example, in a case where an emotion recognition result for a participant which emotion recognition result is included in the presentation content indicates that an emotion of the participant is negative, the generation section 223 places, in the virtual space, the avatar whose eyes are closed and whose facial expression looks sad, as illustrated in a participant PA7 in FIG. 5.

Further, the generation section 223 may control a movement of the avatar in accordance with the presentation content. For example, as illustrated in FIG. 5, the generation section 223 may control movement of cars attached to the avatar.

As an example of this case, in a case where an emotion recognition result for a participant which emotion recognition result is included in the presentation content indicates that an emotion of the participant is in a neutral state, the generation section 223 places, in the virtual space, the participant PA4 whose ear tips are drooping.

As another example, in a case where an emotion recognition result for a participant which emotion recognition result is included in the presentation content indicates that an emotion of the participant is positive, the generation section 223 places, in the virtual space, the participant PA5 or PA6 whose ears as a whole have been moved.

As still another example, in a case where an emotion recognition result for a participant which emotion recognition result is included in the presentation content indicates that an emotion of the participant is negative, the generation section 223 places, in the virtual space, the participant PA6 whose ears as a whole are drooping.

Further, the generation section 223 may control a voice of the avatar in accordance with the presentation content. For example, in a case where an emotion recognition result for a participant which emotion recognition result is included in the presentation content indicates that an emotion of the participant is positive, the generation section 223 generates a conference image including the voice of the avatar, such as “happy”, “pleasant”, or “funny”.

Furthermore, the generation section 223 may place, in the virtual space, not only the avatar but also an icon that is changed in accordance with an emotion recognition result for a participant which emotion recognition result is included in the presentation content. An example in which the generation section 223 places the icon in the virtual space will be described later.

Thus, the generation section 223 controls, in accordance with the presentation content, a facial expression, a movement, or a voice of an avatar of the first participant which avatar is placed in the virtual space. With this configuration, the generation section 223 can suitably present a reaction of a participant in an online conference.

### (Flow of Control Method S2 for Online Conference System 100)

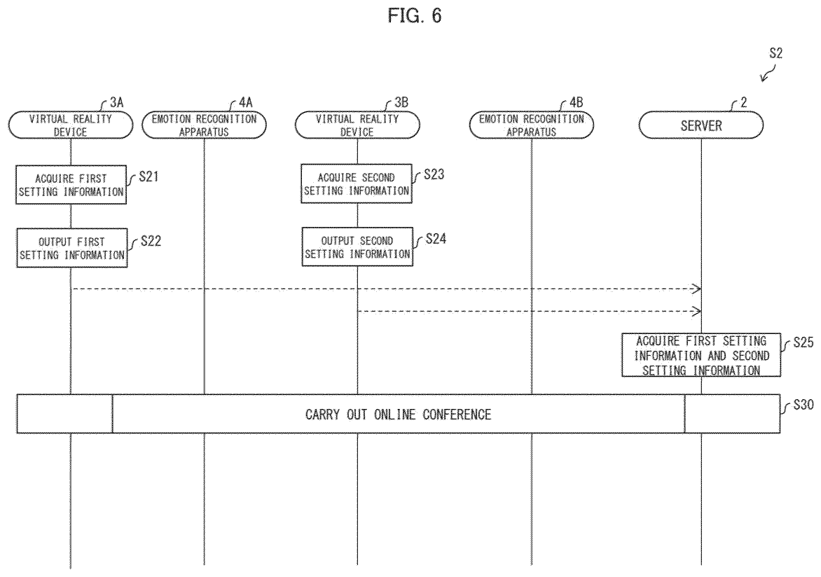

The following description will discuss, with reference to FIG. 6, a flow of a control method S2 for the online conference system 100 according to the present example embodiment. FIG. 6 is a sequence diagram illustrating the flow of the control method S2 for the online conference system 100 according to the present example embodiment.

### (Step S21)

In step S21, the acquisition section 321A of the virtual reality device 3A acquires the first setting information via the input section 34A.

### (Step S22)

In step S22, the acquisition section 321A outputs, to the server 2 via the communication section 31A, the first setting information acquired in step S21.

### (Step S23)

In step S23, an acquisition section 321B of the virtual reality device 3B acquires the second setting information via an input section 34B.

### (Step S24)

In step S24, the acquisition section 321B outputs, to the server 2 via a communication section 31B, the second setting information acquired in step S23.

Note that an order in which (i) steps S21 and S22 and (ii) steps S23 and S24 are carried out is not limited.

### (Step S25)

In step S25, the acquisition section 11 of the server 2 acquires, via the communication section 21, the first setting information output from the virtual reality device 3A and the second setting information output from the virtual reality device 3B. The acquisition section 11 stores the acquired first setting information and the acquired second setting information in the storage section 23.

### (Step S30)

In step S30, an online conference is carried out in the online conference system 100.

### (Example of Process of Online Conference)

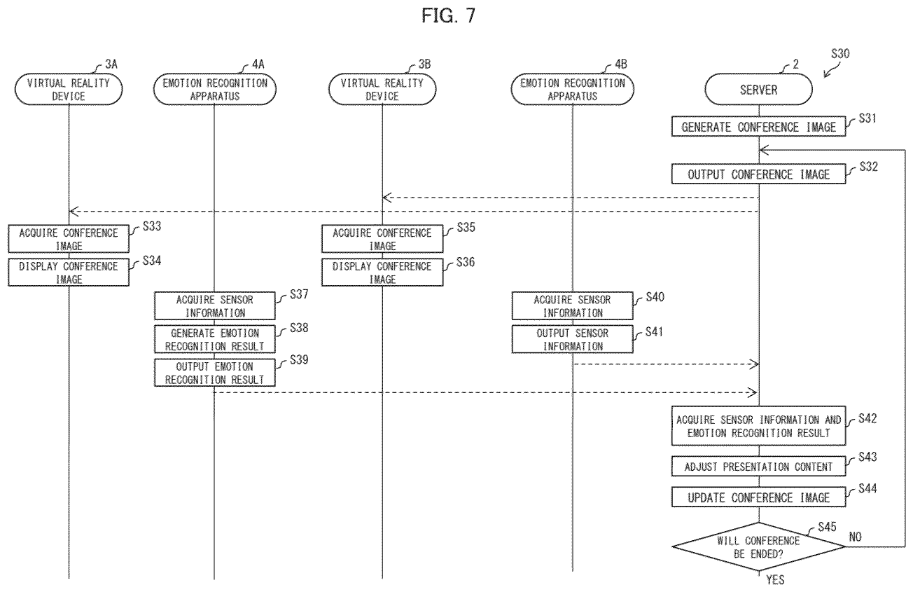

The following description will discuss, with reference to FIG. 7, a flow of step S30, which is a process of the online conference carried out in the online conference system 100. FIG. 7 is a sequence diagram showing the flow of the process of the online conference carried out in the online conference system 100 according to the present example embodiment.

### (Step S31)

In step S31, the generation section 223 generates a conference image of the online conference. For example, the generation section 223 that has acquired a moving image from the virtual reality device 3 generates the conference image including the moving image. As another example, in a case where an avatar is used, the generation section 223 generates the conference image including the avatar. The generation section 223 stores the generated conference image in the storage section 23.

### (Step S32)

In step S32, the presentation section 13 acquires the conference image stored in the storage section 23, and outputs the conference image to the virtual reality device 3 via the communication section 21.

### (Step S33)

In step S33, the acquisition section 321A of the virtual reality device 3A acquires, via the communication section 31A, the conference image output in step S32. The acquisition section 321A supplies the acquired conference image to the display section 322A.

### (Step S34)

In step S34, the display section 322A displays, on the display 36A, the conference image supplied from the acquisition section 321A in step S33.

### (Step S35)

In step S35, the acquisition section 321B of the virtual reality device 3B acquires, via the communication section 31B, the conference image output in step S32. The acquisition section 321B supplies the acquired conference image to a display section 322B.

### (Step S36)

In step S36, the display section 322B displays, on a display 36B, the conference image supplied from the acquisition section 321B in step S35.

Note that an order in which (i) steps S33 and S34 and (ii) steps S35 and S36 are carried out is not limited.

### (Step S37)

In step S37, the emotion recognition section 421A of the emotion recognition apparatus 4A acquires sensor information from the sensor section 44A.

### (Step S38)

In step S38, the emotion recognition section 421A generates an emotion recognition result on the basis of the sensor information acquired in step S37.

### (Step S39)

In step S39, the emotion recognition section 421A outputs, to the server 2 via the communication section 41A, the emotion recognition result generated in step S38.

Note here that the process in steps S37 to S39 may be configured to be carried out by being triggered by the emotion recognition section 421A acquiring, from the virtual reality device 3A, a signal indicating that step S34 has been carried out, or may be configured to be carried out at all times while step S30 is being carried out, regardless of the process in step S34.

### (Step S40)

In step S40, an emotion recognition section 421B of the emotion recognition apparatus 4B acquires sensor information from a sensor section 44B. Note here that the sensor information acquired by the emotion recognition section 421B in step S40 includes at least a voice of an utterance of the second participant.

### (Step S41)

In step S41, the emotion recognition section 421B outputs, to the server 2 via a communication section 41B, the sensor information acquired in step S40.

Note here that the process in steps S40 and S41 may be configured to be carried out at all times while step S30 is being carried out, regardless of the process in step S36. Further, in step S40, the emotion recognition section 421B may generate an emotion recognition result on the basis of the acquired sensor information. In this case, in step S41, the emotion recognition section 421B may output the sensor information and the generated emotion recognition result to the server 2.

### (Step S42)

In step S42, the acquisition section 11 of the server 2 acquires, via the communication section 21, the emotion recognition result output in step S39 and the sensor information output in step S41. The acquisition section 11 stores the acquired emotion recognition result and the acquired sensor information in the storage section 23.

### (Step S43)

The adjustment section 12 acquires the first setting information, the second setting information, the emotion recognition result, and the sensor information, each of which is stored in the storage section 23, and adjusts the presentation content. A process in which the adjustment section 12 adjusts the presentation content is as described earlier.

### (Step S44)

In step S44, the generation section 223 generates a conference image of the online conference. As described earlier, the generation section 223 may generate a virtual space for holding the online conference.

### (Step S45)

In step S45, the control section 22 of the server 2 determines whether a conference will be ended. For example, in a case where a certain period of time has elapsed since the start of the conference, the control section 22 determines that the conference will be ended. As another example, the control section 22 that has acquired, from the virtual reality device 3, an instruction to end the conference determines that the conference will be ended.

In step S45, in a case where it is determined that the conference will be ended, the process of the online conference, which process is illustrated in FIG. 7, is ended.

In contrast, in a case where it is determined in step S45 that the conference has not been ended, the process returns to step S32, and the presentation section 13 acquires the conference image (i.e., the updated conference image) stored in the storage section 23, and outputs the conference image to the virtual reality device 3 via the communication section 21.

Note here that, as described earlier, the conference image stored in the storage section 23 may be a conference image including the presentation content. Note also that, in a case where the conference image stored in the storage section 23 is a conference image including no presentation content, the presentation section 13 outputs the conference image and the presentation content to at least the virtual reality device 3B in step S32, which is carried out again.

### (Example of Conference Image of Online Conference)

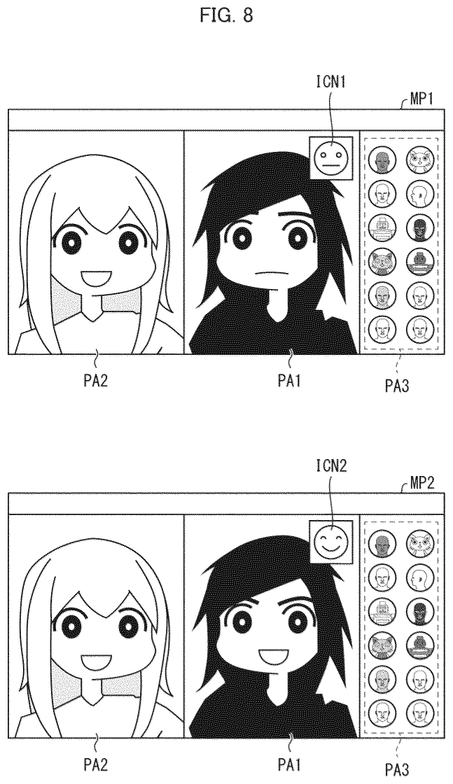

The following description will discuss, with reference to FIG. 8, an example of the conference image of the online conference which conference image is generated by the generation section 223. FIG. 8 is a view illustrating an example of the conference image of the online conference which conference image is generated by the generation section 223 in the present example embodiment.

For example, as illustrated in FIG. 8, the generation section 223 generates a conference image MP1 including a first participant PA1 and a second participant PA2. As each of the first participant PA1 and the second participant PA2, a moving image including, as a subject, the first participant or the second participant acquired from the virtual reality device 3 may be included as it is in the conference image MP1. Alternatively, the first participant PA1 and the second participant PA2 may be avatars representing the first participant and the second participant, respectively.

Further, as illustrated in FIG. 8, the generation section 223 may include a plurality of other first participants PA3 in the conference image MP1. As in the case of above-described configuration, each of the plurality of other first participants PA3 may be a moving image acquired from the virtual reality device 3, or may be an avatar.

Furthermore, as illustrated in FIG. 8, the generation section 223 may include, in the conference image MP1, an icon ICN1 corresponding to an emotion recognition result for the first participant PA1 which emotion recognition result is included in the presentation content.

Moreover, in a case where the emotion recognition result for the first participant PA1 which emotion recognition result is included in the conference image MP1 has been changed, the generation section 223 generates a conference image MP2 on the basis of the changed emotion recognition result as illustrated in FIG. 8.

For example, in a case where the emotion recognition result for the first participant PA1 has been changed to a positive emotion, the generation section 223 changes a facial expression of the first participant PA1 to a facial expression indicating that the first participant PA1 has expressed a positive emotion. In addition, the generation section 223 also changes, to an icon ICN2 indicating that the first participant PA1 has expressed a positive emotion, the icon ICN1 corresponding to the emotion recognition result for the first participant PA1.

As another example, the generation section 223 may be configured to change a background color in accordance with the emotion recognition result for the first participant PA1. For example, in a case where the first participant PA1 has expressed a positive emotion, the generation section 223 changes a color of a background of the first participant PA1 to green. In a case where the first participant PA1 has expressed a negative emotion, the generation section 223 may change the color of the background of the first participant PA1 to red.

As described above, in the online conference system 100 according to the present example embodiment, the acquisition section 11 of the server 2 acquires, from the emotion recognition apparatus 4A, the emotion recognition result for the first participant who participates in the online conference, the adjustment section 12 of the server 2 adjusts the presentation content of the emotion recognition result acquired by the acquisition section 11, and the presentation section 13 of the server 2 presents the adjusted presentation content to the virtual reality device 3B used by the second participant.

Thus, according to the online conference system 100 according to the present example embodiment, the presentation content including the adjusted emotion recognition result for the first participant can be presented to the second participant. This brings about an effect of making it possible to suitably present a reaction of a participant in an online conference.

### Third Example Embodiment

The following description will discuss a third example embodiment of the present invention in detail with reference to the drawings. Note that members having functions identical to those of the respective members described in the above-described example embodiments are given respective identical reference numerals, and a description of those members is not repeated.

### (Overview of Online Conference System 100A)

In an online conference system 100A according to the present example embodiment, a presentation content in a past certain period of time or at a past certain point in time is presented. More specifically, a presentation section 13 of a server 2 acquires a presentation content in a past certain period of time or at a past certain point in time which presentation content is stored in a storage section 23, and outputs the presentation content to a virtual reality device 3. Since the rest of the configuration of the online conference system 100A is identical to that of the above-described online conference system 100, a description thereof is omitted.

### (Flow of Control Method S3 for Online Conference System 100)

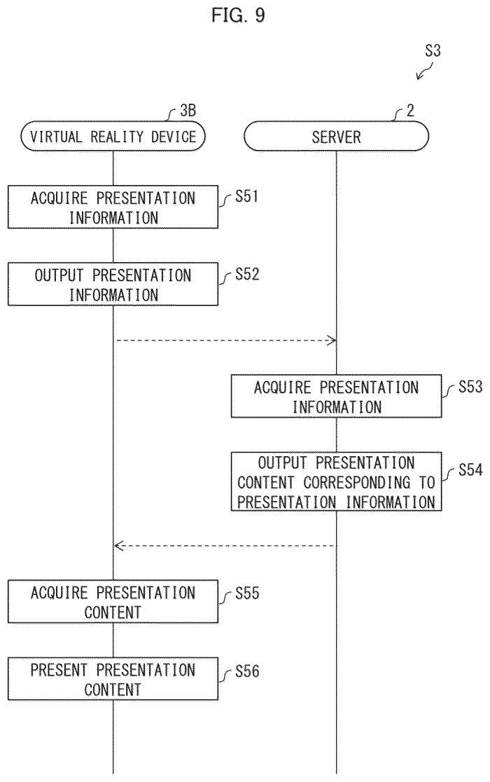

The following description will discuss, with reference to FIG. 9, a flow of a control method S3 for the online conference system 100A according to the present example embodiment. FIG. 9 is a sequence diagram showing the flow of the control method S3 for the online conference system 100A according to the present example embodiment. FIG. 9 takes, as an example, a case where the server 2 outputs, to the virtual reality device 3B, a presentation content in a past certain period of time or at a past certain point in time. Note, however, that a device to which the server 2 outputs the presentation content is not limited to the virtual reality device 3B.

### (Step S51)

In step S51, an acquisition section 321B of the virtual reality device 3B acquires, via an input section 34B, presentation information indicating a past certain period of time or a certain point in time.

### (Step S52)

In step S52, the acquisition section 321B outputs, to the server 2 via a communication section 31B, the presentation information acquired in step S51.

### (Step S53)

In step S53, an acquisition section 11 of the server 2 acquires, via a communication section 21, the presentation information output from the virtual reality device 3B in step S52. The acquisition section 11 stores the acquired presentation information in the storage section 23.

### (Step S54)

In step S54, the presentation section 13 acquires the presentation information stored in the storage section 23, and acquires, from the storage section 23, a presentation content corresponding to the presentation information. The presentation section 13 outputs the acquired presentation content to the virtual reality device 3B via the communication section 21.

### (Step S55)

In step S55, the acquisition section 321B of the virtual reality device 3B acquires, via the communication section 31B, the presentation content output from the server in step S54. The acquisition section 321B supplies the acquired presentation content to a display section 322B.

### (Step S56)

The display section 322B acquires the presentation content supplied from the acquisition section 321B in step S55. The display section 322B displays the acquired presentation content on a display 36B.

### (Example of Display of Presentation Content)

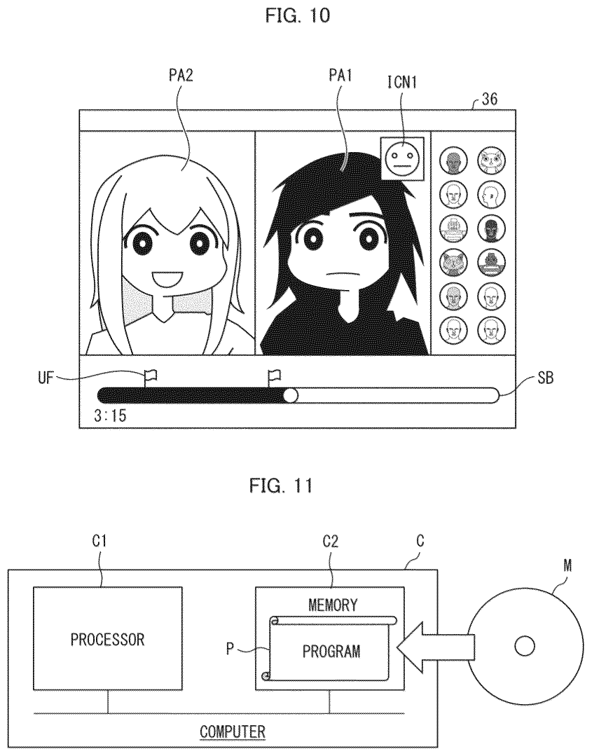

The following description will discuss, with reference to FIG. 10, an example of the presentation content displayed on the display 36B by the display section 322B. FIG. 10 is a view illustrating an example of the presentation content displayed on the display 36B by the display section 322B in the present example embodiment.

As illustrated in FIG. 10, the display section 322B may display a conference image of an online conference which conference image corresponds to the acquired presentation content. In other words, as illustrated in FIG. 10, the display section 322B may display a conference image including a first participant PA1, a second participant PA2, and an icon ICN1 corresponding to an emotion recognition result for the first participant PA1, as described in the foregoing example embodiments.

As an example of this configuration, the presentation section 13 of the server 2 may acquire, from the storage section 23, a conference image including the presentation content corresponding to the presentation information, and output the acquired conference image to the virtual reality device 3B. As another example of this configuration, a conference image acquired in the past by the virtual reality device 3B may be configured to be stored in a storage section (not illustrated), and a conference image corresponding to the acquired presentation content may be configured to be acquired from the storage section.

Further, in a case where the acquired presentation content is a presentation content in a certain period of time, the display section 322B may display a conference image including a seek bar SB that indicates a playback time point in the certain period of time, as illustrated in FIG. 10.

In this case, as illustrated in FIG. 10, the display section 322B may include, on the seek bar SB, a flag UF that indicates at which point in time the first participant made an utterance.

As described above, in the online conference system 100A according to the present example embodiment, the presentation section 13 of the server 2 outputs, to the virtual reality device 3, a presentation content in a past certain period of time or at a past certain point in time. Thus, the online conference system 100A according to the present example embodiment makes it possible to present later what kind of reaction the second participant has shown by the utterance of the first participant.

### [Software Implementation Example]

Some or all of the functions of the online conference system 1, the server 2, the virtual reality device 3, and the emotion recognition apparatus 4 may be realized by hardware such as an integrated circuit (IC chip) or may be alternatively realized by software.

In the latter case, the online conference system 1, the server 2, the virtual reality device 3, and the emotion recognition apparatus 4 are each realized by, for example, a computer that executes instructions of a program that is software realizing the functions. FIG. 11 illustrates an example of such a computer (hereinafter referred to as “computer C”). The computer C includes at least one processor C1 and at least one memory C2. The memory C2 stores a program P for causing the computer C to operate as each of the online conference system 1, the server 2, the virtual reality device 3, and the emotion recognition apparatus 4. In the computer C, the functions of the online conference system 1, the server 2, the virtual reality device 3, and the emotion recognition apparatus 4 are realized by the processor C1 reading the program P from the memory C2 and executing the program P.

The processor C1 may be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination thereof. The memory C2 may be, for example, a flash memory, a hard disk drive (HDD), a solid state drive (SSD), or a combination thereof.

Note that the computer C may further include a random access memory (RAM) in which the program P is loaded when executed and/or in which various kinds of data are temporarily stored. The computer C may further include a communication interface through which the computer C transmits and receives data to and from another device. The computer C may further include an input/output interface through which an input/output device(s) such as a keyboard, a mouse, a display and/or a printer is/are to be connected to the computer C.

The program P can also be recorded in a non-transitory tangible storage medium M from which the computer C can read the program P. Examples of such a storage medium M include a tape, a disk, a card, a semiconductor memory, and a programmable logic circuit. The computer C can acquire the program P via the storage medium M. The program P can also be transmitted via a transmission medium. The transmission medium may be, for example, a communication network, a broadcast wave, or the like. The computer C can also acquire the program P via the transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

The whole or part of the example embodiments disclosed above can also be described as below. Note, however, that the present invention is not limited to the following supplementary notes.

### (Supplementary Note 1)

An online conference system including: an acquisition means for acquiring an emotion recognition result for a first participant who participates in an online conference; an adjustment means for adjusting a presentation content of the emotion recognition result; and a presentation means for presenting the adjusted presentation content to a second participant different from the first participant.

### (Supplementary Note 2)

The online conference system according to Supplementary note 1, wherein the adjustment means includes, in the presentation content, a positive emotion recognition result that is included in the emotion recognition result, and includes, in the presentation content, no negative emotion recognition result that is included in the emotion recognition result.

### (Supplementary Note 3)

The online conference system according to Supplementary note 1 or 2, wherein the adjustment means includes, in the presentation content, the emotion recognition result that has been changed by suppressing or emphasizing an emotion included in the emotion recognition result.

### (Supplementary Note 4)

The online conference system according to any one of Supplementary notes 1 to 3, wherein the adjustment means adjusts the presentation content on the basis of an attribute of one or both of the first participant and the second participant.

### (Supplementary Note 5)

The online conference system according to any one of Supplementary notes 1 to 4, wherein the adjustment means adjusts the presentation content on the basis of closeness between the first participant and the second participant.

### (Supplementary Note 6)

The online conference system according to any one of Supplementary notes 1 to 5, wherein the acquisition means acquires an emotion recognition result for the second participant, and the adjustment means adjusts the presentation content during the online conference on the basis of at least one selected from the group consisting of sensor information detected during the online conference, the emotion recognition result for the first participant, and the emotion recognition result for the second participant.

### (Supplementary Note 7)

The online conference system according to any one of Supplementary notes 1 to 6, wherein the adjustment means adjusts the presentation content on the basis of first setting information input by the first participant.

### (Supplementary Note 8)

The online conference system according to any one of Supplementary notes 1 to 7, wherein the adjustment means adjusts the presentation content on the basis of second setting information input by the second participant.

### (Supplementary Note 9)

The online conference system according to any one of Supplementary notes 1 to 8, wherein the presentation means presents the emotion recognition result in real time.

### (Supplementary Note 10)

The online conference system according to any one of Supplementary notes 1 to 9, wherein the presentation means presents the presentation content in a past certain period of time or at a past certain point in time.

### (Supplementary Note 11)

The online conference system according to any one of Supplementary notes 1 to 10, further including a generation means for generating a virtual space for holding the online controlling, in accordance with the conference, and presentation content, a facial expression, a movement, or a voice of an avatar of the first participant which avatar is placed in the virtual space.

### (Supplementary Note 12)

A method for controlling an online conference system, including: (a) acquiring an emotion recognition result for a first participant who participates in an online conference; (b) adjusting a presentation content of the emotion recognition result; and (c) presenting the adjusted presentation content to a second participant different from the first participant, (a), (b), and (c) each being carried out by at least one processor.

### (Supplementary Note 13)

A program for causing a computer to function as: an acquisition means for acquiring an emotion recognition result for a first participant who participates in an online conference; an adjustment means for adjusting a presentation content of the emotion recognition result; and a presentation means for presenting the adjusted presentation content to a second participant different from the first participant.

### [Additional Remark 3]

The whole or part of the example embodiments disclosed above further can also be expressed as below.

An online conference system including at least one processor, the at least one processor carrying out: an acquisition process for acquiring an emotion recognition result for a first participant who participates in an online conference; an adjustment process for adjusting a presentation content of the emotion recognition result; and a presentation process for presenting the adjusted presentation content to a second participant different from the first participant.

Note that the online conference system may further include a memory, which may store a program for causing the at least one processor to carry out the . . . process, the . . . process, and the . . . process. Further, the program may be stored in a non-transitory tangible computer-readable storage medium.

### REFERENCE SIGNS LIST

1, 100, 100A Online conference system
11 Acquisition section
12 Adjustment section
13 Presentation section
2 Server
223 Generation section
3 Virtual reality device
4 Emotion recognition apparatus

What is claimed is:

1. An online conference system comprising at least one processor, the at least one processor carrying out:
an acquisition process for acquiring an emotion recognition result for a first participant who participates in an online conference;
an adjustment process for adjusting a presentation content of the emotion recognition result; and
a presentation process for presenting the adjusted presentation content to a second participant different from the first participant.

2. The online conference system according to claim 1, wherein in the adjustment process, the at least one processor includes, in the presentation content, a positive emotion recognition result that is included in the emotion recognition result, and includes, in the presentation content, no negative emotion recognition result that is included in the emotion recognition result.

3. The online conference system according to claim 1, wherein in the adjustment process, the at least one processor includes, in the presentation content, the emotion recognition result that has been changed by suppressing or emphasizing an emotion included in the emotion recognition result.

4. The online conference system according to claim 1, wherein in the adjustment process, the at least one processor adjusts the presentation content on the basis of an attribute of one or both of the first participant and the second participant.

5. The online conference system according to claim 1, wherein in the adjustment process, the at least one processor adjusts the presentation content on the basis of closeness between the first participant and the second participant.

6. The online conference system according to claim 1, wherein
in the acquisition process, the at least one processor acquires an emotion recognition result for the second participant, and
in the adjustment process, the at least one processor adjusts the presentation content during the online conference on the basis of at least one selected from the group consisting of sensor information detected during the online conference, the emotion recognition result for the first participant, and the emotion recognition result for the second participant.

7. The online conference system according to claim 1, wherein in the adjustment process, the at least one processor adjusts the presentation content on the basis of first setting information input by the first participant.

8. The online conference system according to claim 1, wherein in the adjustment process, the at least one processor adjusts the presentation content on the basis of second setting information input by the second participant.

9. The online conference system according to claim 1, wherein in the presentation process, the at least one processor presents the emotion recognition result in real time.

10. The online conference system according to claim 1, wherein in the presentation process, the at least one processor presents the presentation content in a past certain period of time or at a past certain point in time.

11. The online conference system according to claim 1, wherein the at least one processor further carries out a generation process for generating a virtual space for holding the online conference, and controlling, in accordance with the presentation content, a facial expression, a movement, or a voice of an avatar of the first participant which avatar is placed in the virtual space.

12. A method for controlling an online conference system, comprising:
(a) acquiring an emotion recognition result for a first participant who participates in an online conference;
(b) adjusting a presentation content of the emotion recognition result; and
(c) presenting the adjusted presentation content to a second participant different from the first participant,
(a), (b), and (c) each being carried out by at least one processor.

13. A non-transitory storage medium storing therein a program for causing a computer to carry out:
an acquisition process for acquiring an emotion recognition result for a first participant who participates in an online conference;
an adjustment process for adjusting a presentation content of the emotion recognition result; and
a presentation process for presenting the adjusted presentation content to a second participant different from the first participant.
